(19) United States
(12) Patent Application Publication
(10) Pub. No.: US 2015/0281158 A1
(43) Pub. Date: Oct. 1, 2015

(54) PARTLY MASKED MEDIA CONTENTS DISTRIBUTION AND MANAGEMENT

(71) Applicant: PREEVIOO BVBA, Antwerpen (BE)

(72) Inventors: Emmanuel GRINSPAN, RaAnana (IL); Sascha Daskal, Rhode St-Genese (BE)

(21) Appl. No.: 14/669,164

(22) Filed: Mar. 26, 2015

Related U.S. Application Data
(60) Provisional application No. 61/970,932, filed on Mar. 27, 2014.

(51) Int. Cl. H04L 12/58; H04L 29/06; G06F 3/0484

(52) U.S. Cl. CPC H04L 51/18; G06F 3/04847; G06F 3/04842; H04L 65/60

(57) ABSTRACT

A method of generating media content with revealable area(s), comprising: displaying an image on a display of a sender client terminal, marking area(s) in the image by a marking user input made by a sender which uses the sender client terminal, associating unmasking term(s), generating from the media content a partly masked media content having the at least one area masked by at least one masking object, forwarding the partly masked media content and the at least one unmasking term to be presented on at least one recipient client terminal of at least one recipient, and monitoring a compliance with the at least one unmasking term. The at least one masking object is automatically removed to reveal the at least one masked area in a presentation on a display of the at least one recipient client terminal when the at least one unmasking term is complied with.

### RELATED APPLICATION

This application claims the benefit of priority under 35 USC 119(e) of U.S. Provisional Patent Application No. 61/970,932 filed Mar. 27, 2014, the contents of which are incorporated herein by reference in their entirety.

### BACKGROUND

The present invention, in some embodiments thereof, relates to media communication and, more specifically, but not exclusively, to methods and systems of distributing processed media files.

During the last years various messaging applications have been developed for client terminals such as Smartphones and Tablets. Some of these messaging applications focus on distributing media files such as images and video files. Some of these messaging applications include privacy protection mechanisms for deleting media files after a certain period. For example, Snapchat™ is a photo messaging application which allows users to take photos, record videos, add text and drawings, and send them to a controlled list of recipients. Users may set a time limit for how long recipients can view the photos or videos (for example, the range is from 1 to 10 seconds in Snapchat™), after which they will be hidden from the recipient's device and deleted from servers of the service.

### SUMMARY

According to some embodiments of the present invention, there is provided a method of generating a partly masked media content with at least one revealable area, comprising: displaying an media content on a display of a sender client terminal, marking at least one area in the media content by a marking user input made by a sender which uses the sender client terminal, associating at least one unmasking term, generating from the media content a partly masked media content having the at least one area masked by at least one masking object, forwarding the partly masked media content and the at least one unmasking term to be presented on at least one recipient client terminal of at least one recipient, and monitoring a compliance with the at least one unmasking term. The at least one masking object is automatically removed to reveal the at least one masked area in a presentation on a display of the at least one recipient client terminal when the at least one unmasking term is complied with.

Optionally, the partly masked media content is an image.

Optionally, the associating comprises receiving a recipient user input indicative of the at least one recipient from the sender; wherein the forwarding comprises sending the partly masked media content with the at least one unmasking term to a client module installed on the at least one recipient client terminal via a computer network.

Optionally, the forwarding comprises sending the partly masked media content to a social network service for posting the partly masked media content; wherein the monitoring is performed at the social network service.

More optionally, the at least one unmasking term defines an amount of social network operations the posting.

Optionally, the associating comprises receiving from the sender which uses the sender client terminal a user input indicative of the at least one unmasking term.

Optionally, the marking is performed by a finger touch event of the sender on a region of the display while the media content is presented.

Optionally, the at least one area comprises at least one object; wherein the media content a video file; further comprising processing the video file to identify the at least one object in a plurality of frames and masking the at least one object in each one of the plurality of frames.

Optionally, the media content is a text content; the at least one area includes a segment of the text content.

Optionally, the method further comprises adding to the partly masked media content a text provided by the sender.

Optionally, the associating at least one unmasking term comprising generating the at least one unmasking term from a query and a response to the query which re set by the sender.

Optionally, the at least one unmasking term defines a period for masking the at least one area of the partly masked media content.

More optionally, the period is user defined.

Optionally, the at least one unmasking term defines an amount of reactions from the at least one recipient to the presentation of the partly masked media content.

Optionally, the at least one masking object is automatically diminished over a period to reveal the at least one area.

More optionally, the diminishing is made by fading.

Optionally, the method further comprises receiving at the sender client terminal a notification indicative of the compliance and presenting the notification on the display.

Optionally, the method further comprises capturing the media content by the sender client terminal.

Optionally, the at least one masking object is an overlay added to the selected media content.

Optionally, the at least one area masked by at least one masking object comprises a plurality areas masked by a plurality of masking objects; wherein the plurality of masking objects are sequentially removed in a plurality of sequential iterations to reveal separately each one of the plurality of masked areas in the presentation when the at least one unmasking term is complied with.

According to some embodiments of the present invention, there is provided a sender client terminal for distributing an image with at least one revealable area.

The sender client comprises a display which displays a media content on a display of a sender client terminal, a processor, a graphical user interface for marking at least one area in the media content by a marking user input made by a sender which uses the sender client terminal, and a client module which generates from the media content a partly masked media content having the at least one area masked by at least one masking object and associated with at least one unmasking term and forwards the partly masked media content to be presented on at least one recipient client terminal of at least one recipient. A compliance with the at least one unmasking term is monitored by a server or a module installed in the at least one recipient client terminal to automatically remove the at least one masking object to reveal the at least one masked area in a presentation on a display of the at least one recipient client terminal when the at least one unmasking term is complied with.

Optionally, the display is a touch screen and the marking is performed by a touch event indicative of a scribble covering at least one object in the media content; wherein the client module processes the media content to identify a region encircling the object and adapting the at least one masking object to cover completely the region.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a method of generating an image with one or more term based revealable areas, according to some embodiments of the present invention;

FIG. 2 is a device of generating an image with one or more term based revealable areas, a device of receiving the image and managing the revealing of the one or more term based revealable areas, and a network, according to some embodiments of the present invention;

FIGS. 3A-3H are images of an exemplary client, a Smartphone, that host an exemplary client module which runs a GUI that allows a sender to select, partly mask, and send and/or post an image associated with one or more unmasking terms, according to some embodiments of the present invention;

FIG. 4 is an image of an exemplary client, a Smartphone, that animates the revealing of masked areas, according to some embodiments of the present invention; and

FIG. 5 is an image of an exemplary client, a Smartphone, which presents a list of names of contact persons and near each name a current number of partly unmasked images and a current number of unmasked images which have been received and unmasked in the past, according to some embodiments of the present invention.

### DETAILED DESCRIPTION

The present invention, in some embodiments thereof, relates to media communication and, more specifically, but not exclusively, to methods and systems of distributing processed media files.

According to some embodiments of the present invention, there are provided methods and systems of sending an image which includes one or more masked areas which the unmasking of these areas depend on a compliance with one or more unmasking terms, such as an elapsing of a predefined period, a response to a user defined query, social network operations which are related to the posting of the images which includes one or more masked area and/or the like.

Optionally, the methods allows a user, referred to herein as a sender, to select an image and to mark areas of the image for masking, for instance by selecting or identifying regions and/or objects in the image. After the marked areas are masked, a partly masked media content with these masked areas is created and distributed, for example forwarded in a message, such as an IM message, and/or posted in a social network site to be available to one or more recipients (e.g. friends, followers, and/or addressees). The partly masked media content is associated with one or more unmasking terms which the compliance therewith determines the revealing of the masked area(s).

The term based unmasking of areas in the selected image generates an experience wherein recipient(s) of the image does not instantly receive the message from the sender but rather has to wait or to comply with user set challenges before the content is fully revealed. This adds curiosity, play, value, gaming, secrecy, privacy to the messaging experience.

Optionally, a compliance with the unmasking term(s) is determined by a client module that is installed at the client terminal of the recipient and/or by a central server.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

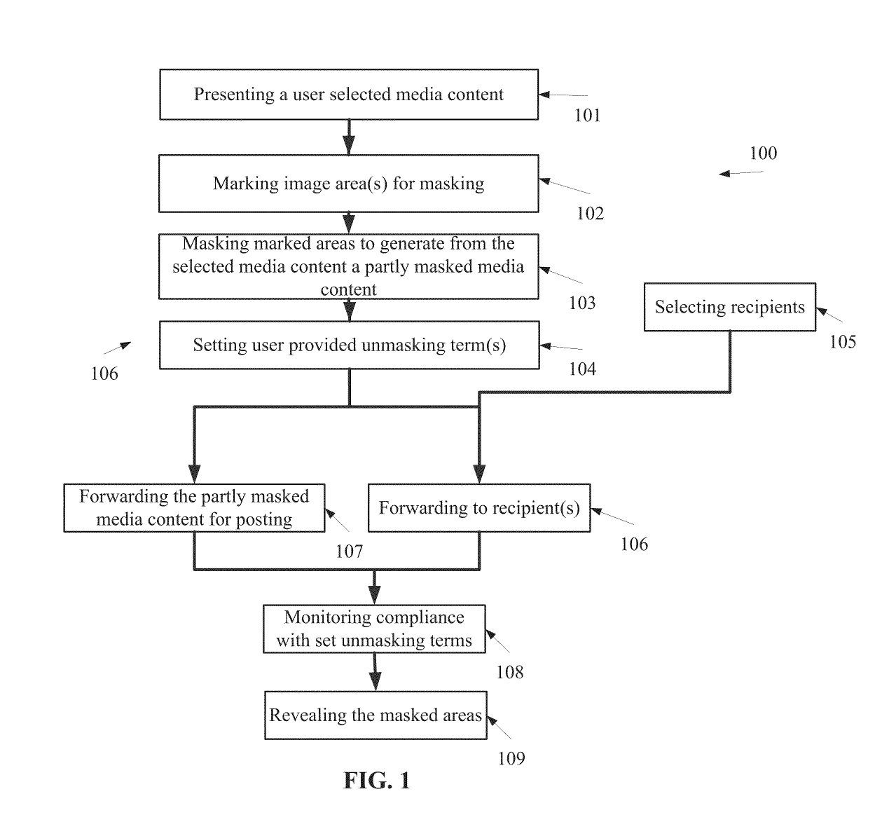

Reference is now made to FIG. 1, which is a flowchart of a method 100 of allowing a user to generate an image with one or more term based revealable areas, referred to herein a partly masked media content, according to some embodiments of the present invention. As used herein, media content means an image, a video, a text paragraph, a graphical content and/or the like. In use, the method 100 is based on creating in one client terminal an image with one or more term based revealable areas, setting one or more mask revealing terms, such as a period of time and/or requirement(s) for a query response(s) and/or requirement(s) for social network actions, and sending the partly revealable image for revealing the one or more term based revealable areas in one or more other client terminals.

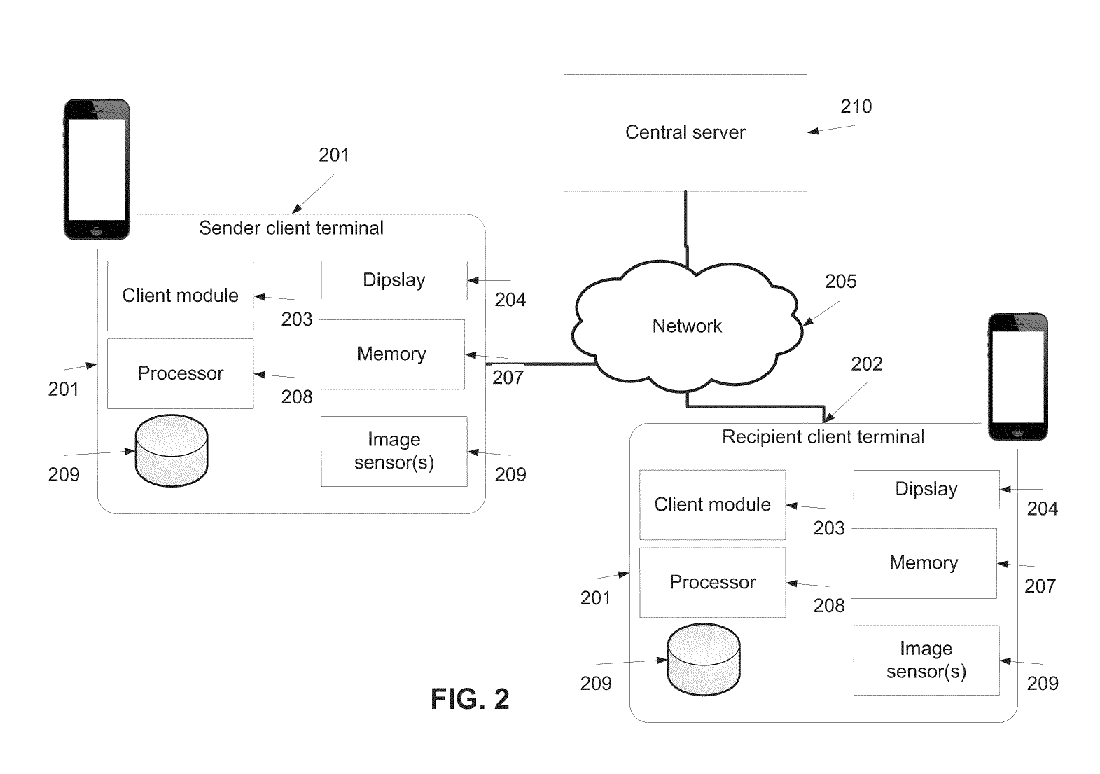

Reference is also made to FIG. 2, which is a schematic illustration of a sender client terminal 201 of generating a partly revealable image, a recipient client terminal 202 of receiving the partly revealable image (optionally one out of many) and a central server 210 managing the revealing of the one or more term based revealable areas in the partly revealable image, and a network 205, according to some embodiments of the present invention. The sender client terminal 201 and/or the recipient client terminal 202 may be a Smartphone, a tablet, a laptop, a wearable device, such as Google glass and/or the like. Each client terminal may include a client module 203 for facilitating the generation of the partly revealable image and/or for facilitating the management of revealing areas in the partly revealable image. The client module 203 may be installed as an application from an application store in the client terminal 201, 202, for example as an app from the app store or from Google Play store. The client terminal 201, 202 includes a processor 208 for executing the client module 203, a memory 207 for storing data, a display 204, such as images and unmasking terms, and one or more camera for capturing images 209.

First, as shown at 101, media content such as an image, a frame of a video file and/or a text is presented on a display 204 of a sender client terminal, such as a cellular phone, for example by a graphical user interface (GUI). For example, the image may be taken using an integrated camera of the client terminal and/or selected from an image gallery. The image may be a frame selected from a video sequence.

The image may be a text segment from a text presented on a screen, for example text inputted by the sender, for example, an image of the text or the text itself. The image may an output of a conversation of text input into an image.

The image may include both an image and a text segment added to the image. Optionally, the image is added to an instant messaging (IM) session held with a user interface of an IM service such as Whatsapp™ and Line™.

Now, as shown at 102, an area in the selected image is marked by the user.

The marking may be performed using a marking tool, for instance using a touch gesture, a cursor maneuver, a touch event, a dragging of a masking object, such as resizable circle or a rectangle or any shape, a drawing action and/or the like. The marking is made by a marking user input made by a sender which uses said sender client terminal. For example, the user may marked a facial area depicting a face, a building a car and/or the like.

Optionally, the GUI incorporates an automatic marking tool for identifying automatically an object for marking in the selected image, for instance a face, a person, an animal, a car, background and/or the like. The automatic identification may be performed using known object identification algorithms, such as face recognition algorithm, filter based algorithm and/or the like.

Optionally, a marking of an object (and/or the masking thereof) may be completed by automatically identifying a region around a user drawn point or line, for instance by identifying a connected component that includes the marked point or line and/or an object encircled by a user set or drawn loop.

Optionally, a number of separate areas are marked.

Now, as shown at 103, a partly masked media content having one or more marked areas masked by a masking object is generated from the selected image. For example, masking object is added to cover the marked areas and/or areas set according to the marking. The masking object may be an overlay added by a graphical editor and/or the like. Optionally, the masking object encoded as a dataset, for example, a vector or a matrix, which sets variables defining the masking object, for example coordinates (e.g. position) size (e.g. area) and/or shape.

Optionally, the user adds text to the partly masked media content. For example, the user may add a textual query or a title to be presented with or before the partly masked media content, for instance “Guess who I met in Paris?” to an image with a masked facial area, “I just came back from the hairdresser with my new blond color” to an image with a masked hair area, “Guess where I am on vacation?” to an image with a covered background or building(s), and “Discover my new sunglasses” to an image of a person with a masked eyes area.

Optionally, the masking object is set to be faded, dimmed or otherwise diminished with time, either iteratively or successively, for example based on user setting and/or automatically.

Optionally, when a plurality of masking object mask a plurality of areas, the plurality of masking objects are sequentially removed in a plurality of sequential iterations to reveal separately each one of the plurality of masked areas in the presentation when said at least one unmasking term is complied with. In such a manner different areas may be revealed with an interlude of several seconds, several minutes, several hours, or several days therebetween.

Optionally, the masking object is colored and/or marked with an icon, for example according to the related one or more unmasking terms. For example, when a timeout period is set, blue mask with an icon of a stopwatch is used to cover the marked areas. In another example, red mask with a question mark icon is used to cover the marked areas. This gives the recipient(s) ability to recognize what kind of mask is used.

Optionally, the masking object is tagged with promotional content, such as a company logo, a symbol, a hyperlinked object, a coupon, and/or the like. This way, a masking object may be sponsored and/or associated with a pay per view/click/impression model and/or the like. Optionally, the masking object is set as an area for rendering or otherwise displaying a video clip.

Optionally, the partly unmasked image is implemented as an animated graphics interchange format (GIF) wherein the passage from one frame to another is controlled according to the one or more unmasking terms. Optionally, the partly unmasked image is implemented as a set of two images, one embedded with the masking objects and the original selected image (or video). Optionally, the partly unmasked image is implemented as an image that is associated with instructions of managing the presentation of graphical elements to mask the marked areas. For example, the partly unmasked image is implemented as an image or a video with an overlay that is controlled according to the unmasking rules.

As shown at 104, the sender may manually provide a user input indicative of one or more unmasking terms. An unmasking term may be a period after which the partly masked media content is exposed, for instance a number of seconds, minutes, or days, for instance 10 seconds, 30 seconds, 5 minutes, 1 day or any intermediate or longer period after the recipient views, opens, receives and/or otherwise sees or accesses or granted with a right to access the partly masked media content for the first time. An unmasking term may be a question set by the user with a predefined answer where the term is complied with when the answer is provided. The question may be presented with the image, for example as described above. An unmasking term may be a predefined number of likes from recipients and/or a predefined percentage of recipients who performed a selected operation. An unmasking term may be a predefined number of views of recipients and/or a predefined percentage of views from the recipients.

An unmasking term may be set with a timeout period after which the partly masked media content is exposed, regardless of whether the unmasking term is complied with. For example, a question may be associated with a timeout period.

Optionally, the term is added to a marked area, for instance when selected by the sender. For instance, every time the sender double clicks on the masking object, a menu appears so that the user can change the trigger conditions and settings before sending or posting the partly masked media content.

The unmasking terms may be added by a GUI that is locally managed by the client module 203 or as a web service that is managed by the central server 210.

As described above, a plurality of areas may be masked with a plurality of separate masking objects. Optionally, each masking object is associated with a different unmasking term, for example one object is removed after 10 min while another is revealed when the number of likes exceeds 50 and/or the percentage of friends who liked the content exceeds 50%. Optionally, all or some of the masking objects are associated with a common unmasking term, for example all revealed after 10 minutes.

Although the above describes the generation of partly masked media content, a partly masked video may similarly be presented and referred to herein, alternately, a partly masked media content. A partly masked video is created by identifying one or more objects marked for masking in one or more of the frames of the videos and processing the video to cover the one or more marked objects in all other frames.

As shown at 105, a user may select one or more recipients. For example, the recipients may be selected from a contact list and/or an instant messaging (IM) session list. In such embodiments, as shown at 106, the partly masked media content is forwarded in association with the one or more unmasking terms to one or more recipient client terminals of one or more recipients. Additionally or alternatively, as shown at 107, the partly masked media content is forwarded to be posted in a webpage or an application, for example in a social network wall or profile.

According to some embodiments of the present invention, the central server 210 performs the forwarding and/or posting. In such embodiments, after the sender sets the unmasking terms 104, the partly masked media content is sent from the sender client terminal 201 to the central server 210 (which may be implemented as a virtual machine or a cloud service). Optionally, the unmasking terms are associated with the masked areas by the client module 203 and sent together with the partly masked media content. Optionally, the unmasking terms are associated with the masked areas by the central server 210, for instance by providing the user with a web service. Optionally, the unmasking terms are defined in a record that is associated with the partly unmasked image, for instance as flags.

Optionally, the user selected recipient(s) and/or posting data (e.g. sender social ID) is associated with the partly unmasked image by the client module 203 and sent to the central server for processing. Optionally, the user selected recipient(s) and/or posting data are associated with the partly unmasked image by the central server 210, for instance by providing the user with a web service. Optionally, the user selected recipient(s) and/or posting data are defined in a record that is associated with the partly unmasked image. Optionally each partly unmasked image is associated with a unique ID.

After association between the partly unmasked image and user selected recipient(s) and/or posting data and/or unmasking terms is completed and optionally recorded the central server 210 performs the forwarding or posting.

Now, as shown at 108, compliance of the unmasking term(s) of the partly masked media content is monitored, for example locally by the client module 203 of the recipient client terminals 202, by the central server 210 or by the service which publishes the partly masked media content. The masking object is automatically removed or diminished so that partly masked media content presented at the recipient client terminal(s) is edited to reveal the masked areas in a presentation on the display 204 of the recipient client terminal(s) 202 when the unmasking term(s) are complied with.

For example, the client module 203 at the recipient client terminal 202 or a social network service receives a message or a pointer to the partly unmasked image and presents the partly unmasked image to the recipient(s) or presents a notification which notifies the recipient(s) about a new message. As described above, the recipient(s) may be addressees of the partly unmasked image and/or followers or social network friends of the sender. Once a recipient opens is presented with the partly unmasked image, a compliance with the unmasking term(s) is monitored, optionally after initiating the unmasking period. When compliance is detected, either by the central server 210 or by the client module 203 the masked areas are unmasked as shown at 109. When the partly masked media content is implemented as a set of two images/video files, the image/video file with the masked area is replaced with the original version thereof. When the partly masked media content is implemented as an image with an overlay, the overlay is diminished or removed to reveal the masked areas.

Optionally, after the term(s) are met, the previously masked area(s) are still marked for the recipient(s). For example, when the recipient accesses the partly masked media content, the masked areas of the partly masked media content are not immediately revealed by rather exposed in a delay of a number of seconds.

Optionally, a compliance with the term(s) is required for unmasking only at the first time the partly masked media content is accessed or presented.

According to some embodiments of the present invention, a number of masked areas are set, optionally each with one or more other unmasking terms. In such embodiments, an image may be revealed iteratively, a step after step, giving the recipient an access to a dynamic content that changes over time.

It should be noted that a compliance with unmasking terms may take a number of hours or days. In such embodiments, masked areas are revealed after a while, giving the user who browses to a certain image a different view each time. In such a manner, users who are interested in seeing the unmasking of the partly masked media content access the web service which publishes the partly masked media content a number of times, for example to browse to a social network webpage every few hours or days to check for an update in an application.

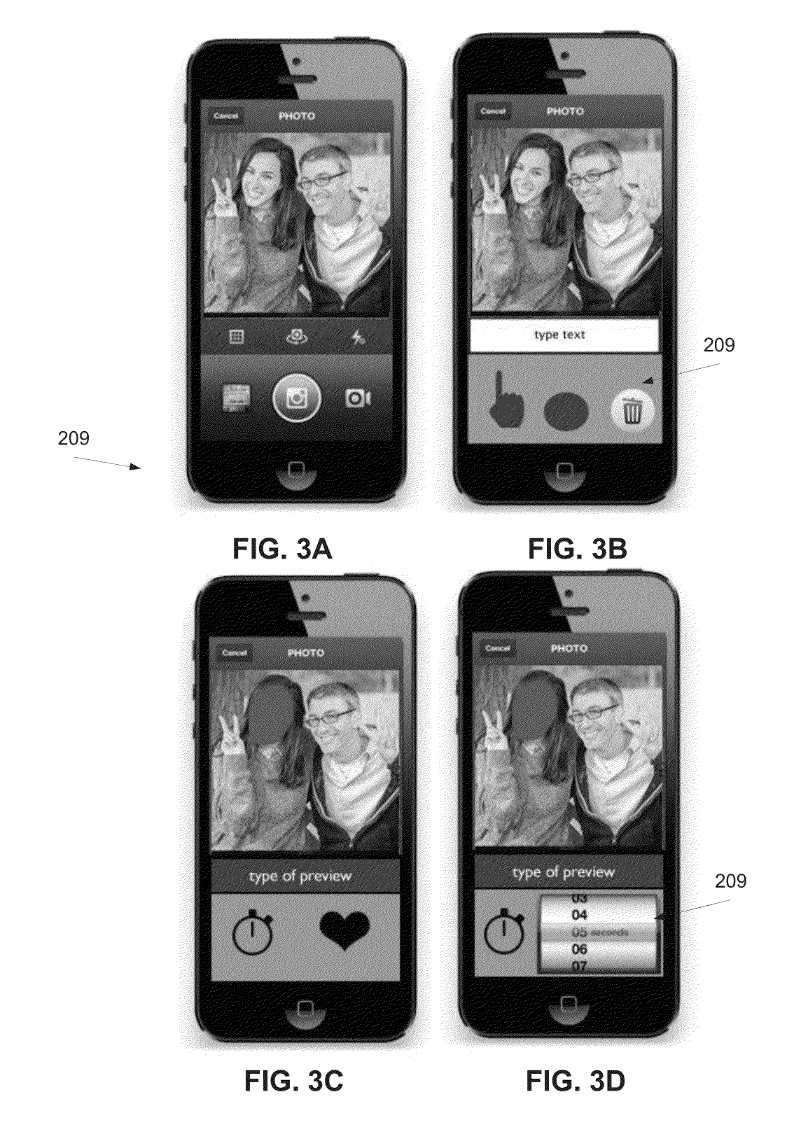

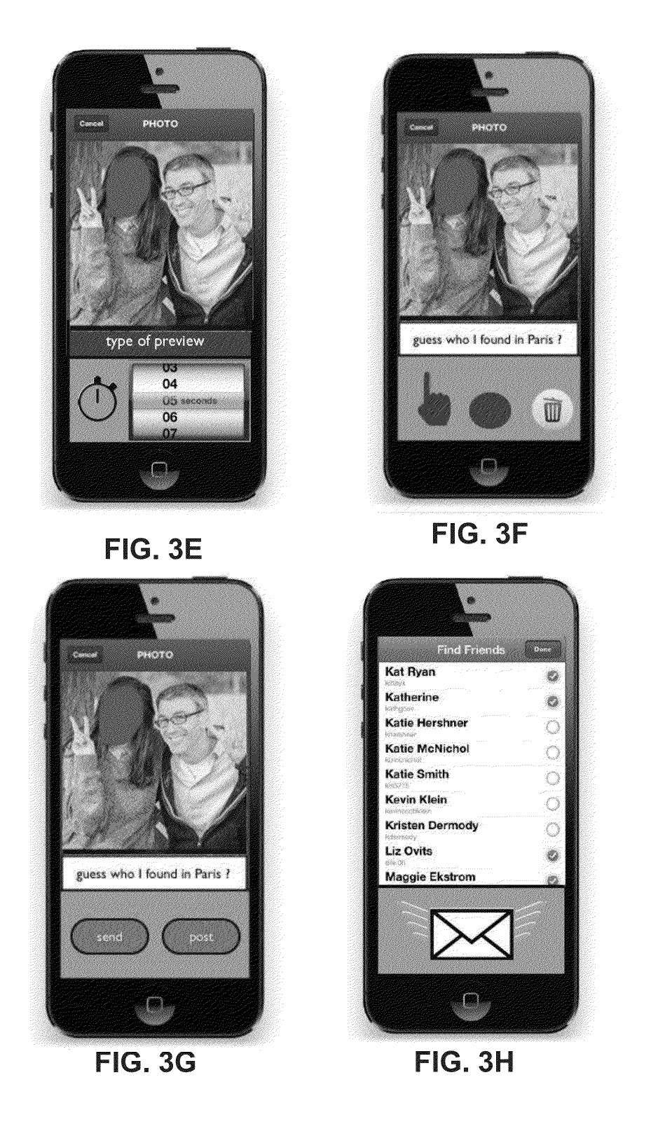

Reference is now made to FIGS. 3A-3H, which are images of an exemplary client, a Smartphone, that host an exemplary client module which runs a GUI that allows a sender to select, partly mask, and send and/or post an image associated with one or more unmasking terms. First, as depicted in FIG. 3A an image is selected using a gallery browsing UI 351 and/or a camera. Now, as shown at FIG. 3B, a text is added. As shown at FIG. 3C, a UI 352 that allows a user to use select a marking tool, such as a finger selection tool that allows marking objects by a scribble or a single touch event or a shape or an image or any portion of an image or a video file which is dragged to cover an area. Now, as shown at FIG. 3D, a UI 353 that allows a user to set an unmasking term is presented to the user. For example, the unmasking term may be a user defined time, a question, and/or a number of likes and/or the percentage of friends who liked the content exceeds a threshold. In another example, the unmasking term may be a user defined location that requires that the recipient would be in a certain location or in proximity to the certain location (e.g. a restaurant, a brunch of a chain of restaurants, a geographical area, and/or the like). As shown at FIG. 3E, a UI that allows a user to set a period is presented when the selected term is a timeout period. Optionally, as shown at FIG. 3F an icon is added to the marked area, depicting the selected unmasking terms. Optionally, as shown at FIG. 3G a UI that allows a user to select whether to post or to send the partly unmasked image is presented to the sender. As shown at FIG. 3H, when the send option is selected one or more recipients are selected from the contact list. As shown at FIG. 4 the revealing of the masked areas may be animated.

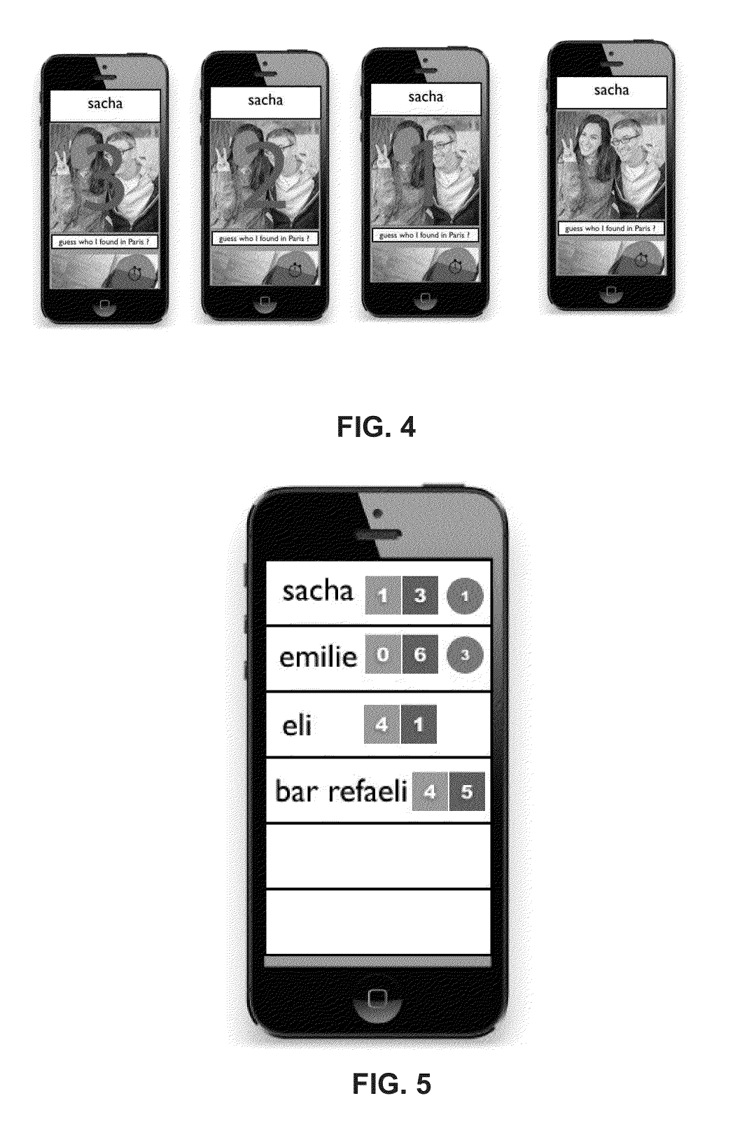

Optionally, an inbox is managed for each user of the system 200, for example by the client module 203. For example, FIG. 5 depicts a GUI presenting such an inbox. In such embodiments, the user may be displayed with a list of names of contact persons and near each name a current number of pending partly unmasked images and a current number of unmasked images which have been received and unmasked in the past. The displaying of a list of names of contact persons allows the sender to see all friends' updates. When a masked area is unmasked, the sender will receive a notification with the updated photo or video that the friend is just seeing.

Optionally, a notification whether a recipient answered a wrong answer, or a correct one is presented. Optionally, a notification that an image received a requested number of likes is presented.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a system, a module, a processor, an image, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of generating a partly masked media content with at least one revealable area, comprising:
displaying an media content on a display of a sender client terminal;
marking at least one area in said media content by a marking user input made by a sender which uses said sender client terminal;
associating at least one unmasking term;
generating from said media content a partly masked media content having said at least one area masked by at least one masking object;
forwarding said partly masked media content and said at least one unmasking term to be presented on at least one recipient client terminal of at least one recipient; and
monitoring a compliance with said at least one unmasking term;
wherein said at least one masking object is automatically removed to reveal said at least one masked area in a presentation on a display of said at least one recipient client terminal when said at least one unmasking term is complied with.

2. The method of claim 1, wherein said partly masked media content is an image.

3. The method of claim 1, wherein said associating comprises receiving a recipient user input indicative of said at least one recipient from said sender; wherein said forwarding comprises sending said partly masked media content with said at least one unmasking term to a client module installed on said at least one recipient client terminal via a computer network.

4. The method of claim 1, wherein said forwarding comprises sending said partly masked media content to a social network service for posting said partly masked media content; wherein said monitoring is performed at said social network service.

5. The method of claim 4, wherein said at least one unmasking term defines an amount of social network operations said posting.

6. The method of claim 1, wherein said associating comprises receiving from said sender which uses said sender client terminal a user input indicative of said at least one unmasking term.

7. The method of claim 1, wherein said marking is performed by a finger touch event of said sender on a region of said display while said media content is presented.

8. The method of claim 1, wherein said at least one area comprises at least one object; wherein said media content a video file; further comprising processing said video file to identify said at least one object in a plurality of frames and masking said at least one object in each one of said plurality of frames.

9. The method of claim 1, wherein said media content is a text content; said at least one area includes a segment of said text content.

10. The method of claim 1, further comprising adding to said partly masked media content a text provided by said sender.

11. The method of claim 1, wherein said associating at least one unmasking term comprising generating said at least one unmasking term from a query and a response to said query which re set by said sender.

12. The method of claim 1, wherein said at least one unmasking term defines a period for masking said at least one area of said partly masked media content.

13. The method of claim 12, wherein said period is user defined.

14. The method of claim 1, wherein said at least one unmasking term defines a location for unmasking said at least one area of said partly masked media content.

15. The method of claim 1, wherein said at least one unmasking term defines an amount of reactions from said at least one recipient to the presentation of said partly masked media content.

16. The method of claim 1, wherein said at least one masking object is automatically diminished over a period to reveal said at least one area.

17. The method of claim 16, wherein said diminishing is made by fading.

18. A computer readable medium comprising computer executable instructions adapted to perform the method of claim 1.

19. The method of claim 1, further comprising receiving at said sender client terminal a notification indicative of said compliance and presenting said notification on said display.

20. The method of claim 1, further comprising capturing said media content by said sender client terminal.

21. The method of claim 1, wherein said at least one masking object is an overlay added to said selected media content.

22. The method of claim 1, wherein said at least one area masked by at least one masking object comprises a plurality areas masked by a plurality of masking objects; wherein said plurality of masking objects are sequentially removed in a plurality of sequential iterations to reveal separately each one of said plurality of masked areas in said presentation when said at least one unmasking term is complied with.

23. A sender client terminal for distributing an image with at least one revealable area, comprising:
a display which displays a media content on a display of a sender client terminal;
a processor;
a graphical user interface for marking at least one area in said media content by a marking user input made by a sender which uses said sender client terminal;
a client module which generates from said media content a partly masked media content having said at least one area masked by at least one masking object and associated with at least one unmasking term and forwards said partly masked media content to be presented on at least one recipient client terminal of at least one recipient; and
wherein a compliance with said at least one unmasking term is monitored by a server or a module installed in said at least one recipient client terminal to automatically remove said at least one masking object to reveal said at least one masked area in a presentation on a display of said at least one recipient client terminal when said at least one unmasking term is complied with.

24. The device of claim 23, wherein said display is a touch screen and said marking is performed by a touch event indicative of a scribble covering at least one object in said media content; wherein said client module processes said media content to identify a region encircling said object and adapting said at least one masking object to cover completely said region.
